(19) United States
(12) Patent Application Publication
(10) Pub. No.: US 2015/0153892 A1
(43) Pub. Date: Jun. 4, 2015

(54) INPUT DEVICE AND INPUT MANAGEMENT METHOD

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: XUE-QIN ZHANG, Shenzhen (CN)

(21) Appl. No.: 14/498,350

(22) Filed: Sep. 26, 2014

(30) Foreign Application Priority Data
Nov. 30, 2013 (CN) 201310622191.0

(51) Int. Cl. G06F 3/041; G06F 3/0488; G06F 3/0484; G06F 3/02

(52) U.S. Cl. CPC G06F 3/0416; G06F 3/0227; G06F 3/04883; G06F 3/04886; G06F 3/04847

(57) ABSTRACT

An input management method switches an input mode between a keyboard input mode, a touchpad input mode, a sketchpad input mode, and a handwriting pen input mode in response to user operation on a button. The method controls a touch screen to display an interface corresponding to the input mode. The method detects the user operation in the interface to determine one or more touch positions and a touch motion in the interface. The method further generates a command according to the one or more touch positions, the touch motion, and the input mode, and transmits the command to an information processing device, to cause the information processing device to execute a function corresponding to the command.

### CROSS-REFERENCE TO RELATED APPLICATIONS

This application claims priority to Chinese Patent Application No. 201310622191.0 filed on Nov. 30, 2013, the contents of which are incorporated by reference herein.

### FIELD

The subject matter herein generally relates to input devices, and particularly, to an input device capable of being switched between a keyboard input mode, a touchpad input mode, a sketchpad input mode, and a handwriting input mode, and a related method.

### BACKGROUND

A mouse and a keyboard are typically employed by a computer as peripheral devices.

### BRIEF DESCRIPTION OF THE DRAWINGS

Implementations of the present technology will now be described, by way of example only, with reference to the attached figures, wherein:

FIG. 1 is an isometric view of an embodiment of an input device

FIG. 2 illustrates a block diagram of an embodiment of an input device.

FIG. 3 illustrates a flowchart of an embodiment of an input management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented.

In general, the word “module,” as used herein, refers to logic embodied in hardware or firmware, or to a collection of software instructions, written in a programming language. The software instructions in the modules can be embedded in firmware, such as in an erasable programmable read-only memory (EPROM) device. The modules described herein can be implemented as either software and/or hardware modules and can be stored in any type of computer-readable medium or other storage device. The term “comprising” means “including, but not necessarily limited to”; it specifically indicates open-ended inclusion or membership in a so-described combination, group, series and the like.

Embodiments of the present disclosure will be described with reference to the accompanying drawings.

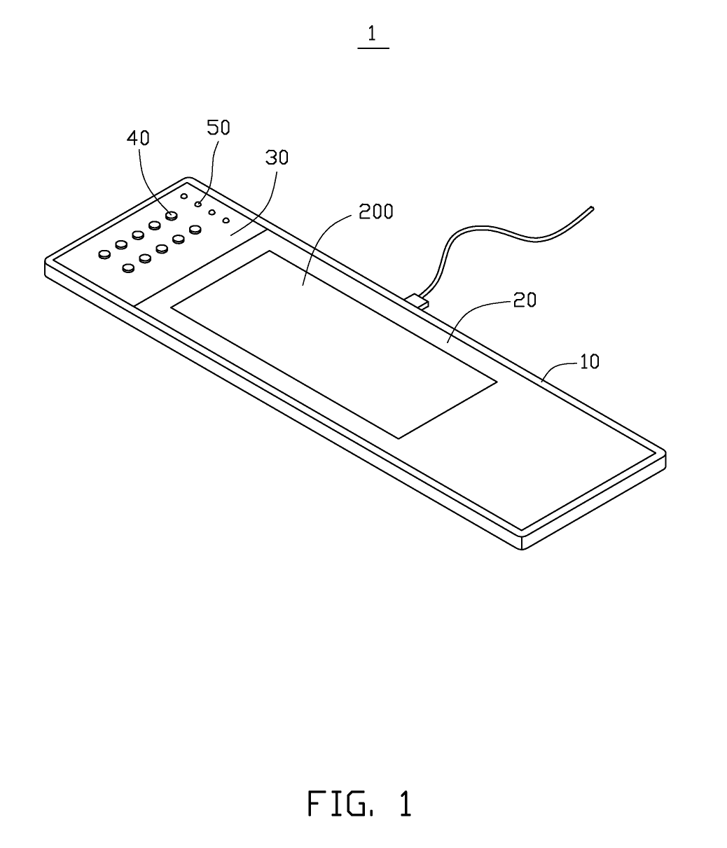

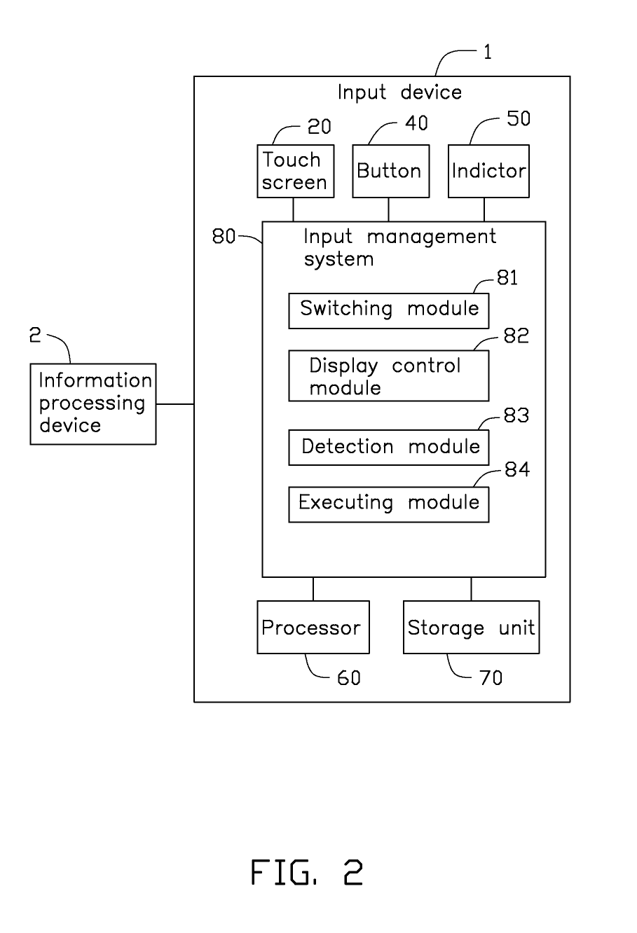

FIGS. 1-2 illustrate an embodiment of an input device 1. The input device 1 includes a housing 10, a touch screen 20, a panel 30, at least one button 40, and a number of indicators 50. The touch screen 20 is received in the housing 10. The touch screen 20 and the panel 30 are flush with each other and cooperate to form a top surface of the input device 1.

The button 40 and the indicators 50 are arranged on a top surface of the panel 30. In the embodiment, the input device 1 has four input modes which are a keyboard input mode, a touchpad input mode, a sketchpad input mode, and a pen input mode. Each indicator 50 can indicate a corresponding input mode.

The input device 1 is connected to an information processing device 2 and can communicate with the information processing device 2 through a wireless method or a wired method. When the input device 1 is connected to the information processing device 2, the input device 1 can serve as an input mechanism of the information processing device 2. In the embodiment, the information processing device 2 can be a portable computer or a tablet computer, for example. In at least one embodiment, the input device 1 can switch the input mode between the keyboard input mode, the touchpad input mode, the sketchpad input mode, and the handwriting input mode. The input device 1 can determine one or more touch positions and touch motion on the touch screen 20, generate a command according to the determined touch positions, the determined touch motion, and the switched input mode, and transmit the generated command to the information processing device 2, causing the information processing device 2 to execute an operation corresponding to the command.

In at least one embodiment, the input device 1 includes a processor 60 and a storage unit 70. An input management system 80 is applied in the input device 1. In at least one embodiment, the input management system 80 can include a switching module 81, a display control module 82, a detection module 83, and an executing module 84. One or more programs of the above function modules can be stored in the storage unit 70 and executed by the processor 60. The processor 60 can be a central processing unit, a digital signal processor, or a single chip, for example. The storage unit 70 can be a hard disk, a compact disk, or a flash memory, for example.

The switching module 81 is configured to switch the input mode between the keyboard input mode, the touchpad input mode, the sketchpad input mode, and the handwriting pen input mode in response to user operation on the button 40, for example, the input mode can be switched from the keyboard input mode to the touchpad input mode in response to user operation on the button 40. In the embodiment, one button 40 is employed as an example, the switching module 81 determines the current input mode, determines the input mode next to the current input mode (hereinafter next input mode) according to a default order, and switches the current input mode to the determined next input mode. For example, the input modes are in the default order: the keyboard input mode, then the touchpad input mode, then the sketchpad input mode, then the handwriting pen input mode, and then back to the keyboard input mode. In other embodiments, four buttons 40 are employed as an example, each button 40 corresponds to one input mode, the switching module 81 determines which button 40 is selected in response to user operation on the button 40, and determines the input mode corresponding to the determined button 40.

The display control module 82 is configured to control the touch screen 20 to display an interface 200 corresponding to the input mode. In the embodiment, the display control module 82 is further configured to control the indicator 50 corresponding to the input mode to emit light.

The detection module 83 is configured to detect the user operation in the interface 200 to determine one or more touch positions and the touch motion in the interface 200.

The executing module 84 is configured to generate a command according to the one or more touch positions, the touch motion, and the input mode, and transmit the command to the information processing device 2. Thus, the information processing device 2 can execute a function corresponding to the transmitted command.

In the embodiment, when the switching module 81 switches the input mode of the input device 1 to the keyboard input mode, the display control module 82 controls the touch screen 20 to display a virtual keyboard, namely the interface 200 displayed on the touch screen 20 is the virtual keyboard. The detection module 83 detects the user operation in the virtual keyboard to determine the one or more touch positions and the touch motion in the virtual keyboard. The executing module 84 determines a virtual character corresponding to each determined touch position, and determines key codes according to each determined virtual character and the determined touch motion. The executing module 84 further generates a command corresponding to the determined key codes, and transmits the generated command to the information processing device 2. For example, when the touch positions includes positions corresponding to a virtual character Ctrl, a virtual character Alt, and a virtual character Delete, and the touch motion is touching three positions simultaneously, the executing module 84 determines the key codes are “Ctrl+Alt+Delete”.

In the embodiment, when the switching module 81 switches the input mode of the input device 1 to the touchpad input mode, the display control module 82 controls the touch screen 20 to display a user interface, namely the interface 200 displayed on the touch screen 20 is the user interface. The size of the user interface can be the same as the size of the touch screen 20. The detection module 83 detects the user operation in the user interface to determine the one or more touch positions and the touch motion in the user interface. The executing module 84 determines a to-be-executed function and/or a movement of a cursor of the information processing device 2 according to the determined touch positions and the determined touch motion. For example, when the detection module 83 detects that the touch position includes a position corresponding to a folder and the touch motion is a tapping two times in quick succession, the executing module 84 determines the to-be-executed function is opening the folder. In the embodiment, the executing module 84 further generates a command corresponding to the to-be-executed function and/or the movement of the cursor of the information processing device 2, and transmits the generated command to the information processing device 2.

In the embodiment, when the switching module 81 switches the input mode of the input device 1 to the sketchpad input mode, the display control module 82 controls the touch screen 20 to display an operation interface which includes a user interface and an instrument interface, namely the interface 200 displayed on the touch screen 20 is the operation interface including the user interface and the instrument interface. The instrument interface lists a number of drawing instruments. The drawing instruments include, but is not limited to, pencil, inked brushes, eraser, different colors, and different sizes of line. The detection module 83 detects the user operation in the user interface to determine the one or more touch positions and the touch motion in the operation interface. The executing module 84 determines each selected drawing instrument in the instruments interface or determines each touch track in the user interface according to the determined touch positions and the touch motion. The executing module 84 further determines the property of each touch track according to the selected drawing instruments. For example, when an inked brush, a blue color, and an 8 pixels line are selected, the executing module 84 determines that the property of the track is blue 8 pixels. The executing module 84 further combines each touch track with the corresponding determined property to generate an image, generates a command corresponding to the generated image, and transmits the generated command to the information processing device 2. In the embodiment, the display control module 82 further controls the touch screen 20 to display each touch track with the corresponding determined property in the user interface.

In the embodiment, when the switching module 81 switches the input mode of the input device 1 to the handwriting pen input mode, the display control module 82 controls the touch screen 20 to display a handwriting input interface, namely the interface 200 displayed on the touch screen 20 is the handwriting input interface. The detection module 83 detects the user operation in the input interface to determine the one or more touch positions and the touch motion in the handwriting input interface. The executing module 84 determines each touch track in the user interface according to the determined touch positions and the touch motion, recognizes a shape of the tracks, and determines the characters similarity to the recognized shape. The display control module 82 controls the touch screen 20 to display the determined characters. The executing module 84 further determines which character is selected according to the touched positions and the touched motion, generates a command according to the selected character, and transmits the generated command to the information processing device 2.

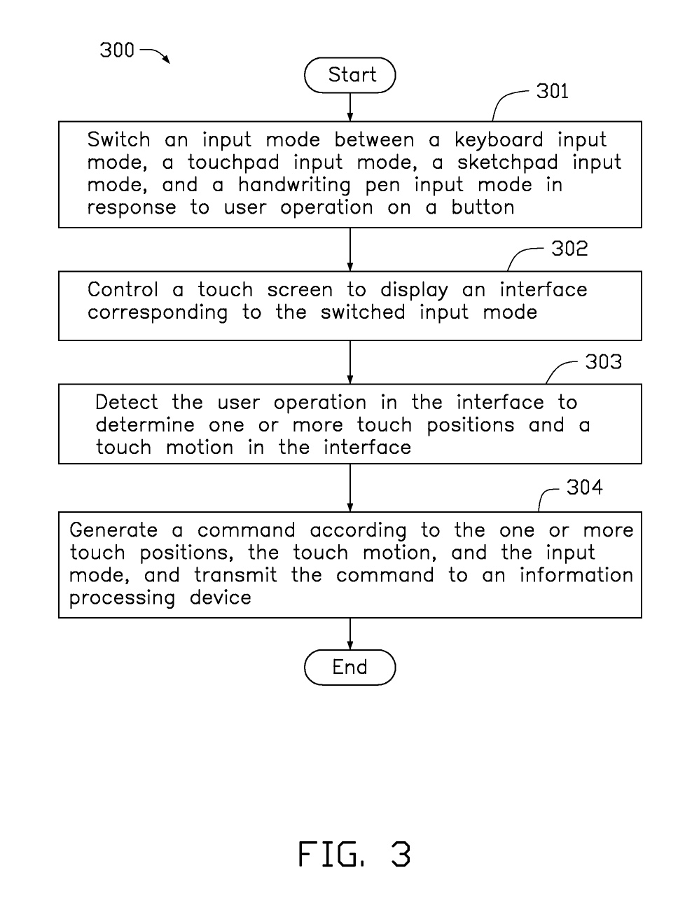

FIG. 3 illustrates a flowchart of an embodiment of an input management method 300. The method 300 is provided by way of example, as there are a variety of ways to carry out the method 300. The method 300 described below can be carried out using the configurations illustrated in FIG. 2, for example, and various elements of these figures are referenced in the explanation of method. Each block shown in FIG. 3 represents one or more processes, methods or subroutines, carried out in the method. Additionally, the illustrated order of blocks is by example only and the order of the blocks can change according to the present disclosure. The method 300 can begin at block 301.

In block 301, a switching module switches an input mode between a keyboard input mode, a touchpad input mode, a sketchpad input mode, and a handwriting pen input mode in response to user operation on a button.

In block 302, a display control module controls a touch screen to display an interface corresponding to the input mode.

In block 303, a detection module detects the user operation in the interface to determine one or more touch positions and a touch motion in the interface.

In block 304, an executing module generates a command according to the one or more touch positions, the touch motion, and the input mode, and transmits the command to an information processing device. Thus, the information processing device can execute the operation corresponding to the command.

In the embodiment, the method further includes:

The display control module controls an indicator corresponding to the input mode to emit light.

In the embodiment, the method further includes:

The display control module controls the touch screen to display a virtual keyboard when the switching module switches the input mode of the input device to the keyboard input mode, namely the interface displayed on the touch screen is the virtual keyboard. The detection module detects the user operation in the virtual keyboard to determine the one or more touch positions and the touch motion in the virtual keyboard. The executing module determines a virtual character corresponding to each determined touch position, determines key codes according to each determined virtual character and the determined touch motion, generates a command corresponding to the determined key codes, and transmits the generated command to the information processing device.

In the embodiment, the method further includes:

The display control module controls the touch screen to display a user interface when the switching module switches the input mode of the input device to the touchpad input mode, namely the interface displayed on the touch screen is the user interface. The detection module detects the user operation in the user interface to determine the one or more touch positions and the touch motion in the user interface. The executing module determines a to-be-executed function and/or a movement of a cursor of the information processing device according to the determined touch positions and the determined touch motion. The executing module further generates a command corresponding to the to-be-executed function and/or the movement of the cursor of the information processing device, and transmits the generated command to the information processing device.

In the embodiment, the method further includes:

The display control module controls the touch screen to display an operation interface which includes a user interface and an instrument interface when the switching module switches the input mode of the input device to the sketchpad input mode, namely the interface displayed on the touch screen is the operation interface including the user interface and the instrument interface. The instrument interface lists a number of drawing instruments. The drawing instruments include, but is not limited to, pencil, inked brushes, eraser, different colors, and different sizes of line. The detection module detects the user operation in the user interface to determine the one or more touch positions and the touch motion in the operation interface. The executing module determines each selected drawing instrument in the instruments interface or determines each touch track in the user interface according to the determined touch positions and the touch motion, and determines the property of each touch track according to the selected drawing instruments. The executing module further combines each touch track with the corresponding determined property to generate an image, generates a command according to the generated image, and transmits the generated command to the information processing device. In the embodiment, the display control module further controls the touch screen to display each touch track with the corresponding determined property in the user interface.

In the embodiment, the method further includes:

The display control module controls the touch screen to display a handwriting input interface when the switching module switches the input mode of the input device to the handwriting pen input mode, namely the interface displayed on the touch screen is the handwriting input interface. The detection module detects the user operation in the input interface to determine the one or more touch positions and the touch motion in the handwriting input interface. The executing module determines each touch track in the user interface according to the determined touch positions and the touch motion, recognizes a shape of the tracks, and determines the characters similarity to the recognized shape. The display control module controls the touch screen to display the determined characters. The executing module further determines which character is selected according to the touched positions and the touched motion, generates a command according to the selected character, and transmits the generated command to the information processing device.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size and arrangement of the parts within the principles of the present disclosure up to, and including, the full extent established by the broad general meaning of the terms used in the claims.

What is claimed is:

1. An input device comprising:
a touch screen;
at least one button;
a storage system;
a processor; and
one or more programs stored in the storage system and executed by the processor, the one or more programs comprising:
a switch module configured to switch an input mode of the input device between a keyboard input mode, a touchpad input mode, a sketchpad input mode, and a handwriting pen input mode, in response to user operation on the at least one button;
a display control module configured to control the touch screen to display an interface corresponding to the input mode;
a detection module configured to detect the user operation in the interface to determine one or more touch positions and a touch motion in the interface; and
an executing module configured to generate a command according to the one or more touch positions, the touch motion, and the switched input mode, and transmit the command to an information processing device, to cause the information processing device to execute a function corresponding to the command.

2. The input device as described in claim 1, wherein when the switching module switches the input mode of the input device to the keyboard input mode:
the display control module controls the touch screen to display a virtual keyboard;
the detection module detects the user operation in the virtual keyboard to determine the one or more touch positions and the touch motion in the virtual keyboard; and
the executing module determines a virtual character corresponding to each determined touch position, determines key codes according to each determined virtual character and the determined touch motion, generates a command corresponding to the determined key codes, and transmits the generated command to the information processing device.

3. The input device as described in claim 1, wherein when the switching module switches the input mode of the input device to the touchpad input mode:
the display control module controls the touch screen to display a user interface;
the detection module detects the user operation in the user interface to determine the one or more touch positions and the touch motion in the user interface; and
the executing module determines a to-be-executed function and/or a movement of a cursor of the information processing device according to the determined touch positions and the determined touch motion, generates a command corresponding to the to-be-executed function and/or the movement of a cursor of the information processing device, and transmits the generated command to the information processing device.

4. The input device as described in claim 1, wherein when the switching module switches the input mode of the input device to the sketchpad input mode:
the display control module controls the touch screen to display an operation interface having a user interface and an instrument interface listing a plurality of drawing instruments;
the detection module detects the user operation in the user interface to determine the one or more touch positions and the touch motion in the operation interface; and
the executing module determines each selected drawing instrument in the instruments interface or determines each touch track in the user interface according to the determined touch positions and the touch motion, determines the property of each touch track according to the selected drawing instruments, combines each touch track with the corresponding determined property to generate an image, generates a command corresponding to the generated image, and transmits the generated command to the information processing device.

5. The input device as described in claim 4, wherein the display control module further controls the touch screen to display each touch track with the corresponding determined property in the user interface.

6. The input device as described in claim 1, wherein when the switching module switches the input mode of the input device to the handwriting pen input mode:
the display control module controls the touch screen to display a handwriting input interface corresponding to the handwriting pen input mode; and controls the touch screen to display characters;
the detection module detects the user operation in the handwriting input interface to determine the one or more touch positions and the touch motion in the handwriting input interface; and
the executing module determines each touch track in the user interface according to the determined touch positions and the touch motion, recognizes a shape of the tracks, and determines the characters similarity to the recognized shape; and determines which character is selected according to the touched positions and the touched motion, generates a command according to the selected character, and transmits the generated command to the information processing device.

7. The input device as described in claim 1, wherein the input device further comprising a plurality of indicators, the display control module is further configured to control the indicator corresponding to the switched input mode to emit light.

8. An input management method comprising:
switching an input mode between a keyboard input mode, a touchpad input mode, a sketchpad input mode, and a handwriting pen input mode in response to user operation on at least one button;
controlling a touch screen to display an interface corresponding to the input mode;
detecting the user operation in the interface to determine one or more touch positions and a touch motion in the interface; and
generating a command according to the one or more touch positions, the touch motion, and the input mode, and transmitting the command to an information processing device, to cause the information processing device to execute a function corresponding to the command.

9. The input management method as described in claim 8, wherein the method further comprises, when the input mode is switched to the keyboard input mode:
controlling the touch screen to display a virtual keyboard;
detecting the user operation in the virtual keyboard to determine the one or more touch positions and the touch motion in the virtual keyboard; and
determining a virtual character corresponding to each determined touch position, determining key codes according to each determined virtual character and the determined touch motion, generating a command corresponding to the determined key codes, and transmitting the generated command to the information processing device.

10. The input management method as described in claim 8, wherein the method further comprises, when the input mode is switched to the touchpad input mode:
controlling the touch screen to display a user interface;
detecting the user operation in the user interface to determine the one or more touch positions and the touch motion in the user interface; and
determining a to-be-executed function and/or a movement of a cursor of the information processing device according to the determined touch positions and the determined touch motion, generating a command corresponding to the to-be-executed function and/or the movement of a cursor of the information processing device, and transmitting the generated command to the information processing device.

11. The input management method as described in claim 8, wherein the method further comprises, when the input mode is switched to the sketchpad input mode:
controlling the touch screen to display an operation interface having a user interface and an instrument interface listing a plurality of drawing instruments;
detecting the user operation in the user interface to determine the one or more touch positions and the touch motion in the operation interface; and
determining each selected drawing instrument in the instruments interface or determining each touch track in the user interface according to the determined touch positions and the touch motion, determining the property of each touch track according to the selected drawing instruments, combining each touch track with the corresponding determined property to generate an image, generating a command corresponding to the generated image, and transmitting the generated command to the information processing device.

12. The input management method as described in claim 11, wherein the method further comprises:
controlling the touch screen to display each touch track with the corresponding determined property in the user interface.

13. The input management method as described in claim 8, wherein the method further comprises, when the input mode is switched to the handwriting pen input mode:
controlling the touch screen to display a handwriting input interface;
detecting the user operation in the handwriting input interface to determine the one or more touch positions and the touch motion in the handwriting input interface;
determining each touch track in the user interface according to the determined touch positions and the touch motion, recognize a shape of the tracks, and determining the characters similarity to the recognized shape;
controlling the touch screen to display the determined characters; and
determining which character is selected according to the touched positions and the touched motion, generating a command according to the selected character, and transmitting the generated command to the information processing device.

14. The input management method as described in claim 8, wherein the method further comprises:
controlling an indicator corresponding to the switched input mode to emit light.

15. A non-transitory storage medium storing a set of instructions, the set of instructions capable of being executed by a processor of an input device, causing the input device to perform an input management method, the method comprising:
switching an input mode between a keyboard input mode, a touchpad input mode, a sketchpad input mode, and a handwriting pen input mode in response to user operation on at least one button;
controlling a touch screen to display an interface corresponding to the input mode;
detecting the user operation in the interface to determine one or more touch positions and a touch motion in the interface; and
generating a command according to the one or more touch positions, the touch motion, and the input mode, and transmitting the command to an information processing device, to cause the information processing device to execute a function corresponding to the command.

16. The non-transitory storage medium as described in claim 15, wherein the method further comprises, when the input mode is switched to the keyboard input mode:
controlling the touch screen to display a virtual keyboard;
detecting the user operation in the virtual keyboard to determine the one or more touch positions and the touch motion in the virtual keyboard; and
determining a virtual character corresponding to each determined touch position, determining key codes according to each determined virtual character and the determined touch motion, generating a command corresponding to the determined key codes, and transmitting the generated command to the information processing device.

17. The non-transitory storage medium as described in claim 15, wherein the method further comprises, when the input mode is switched to the touchpad input mode:
controlling the touch screen to display a user interface;
detecting the user operation in the user interface to determine the one or more touch positions and the touch motion in the user interface; and
determining a to-be-executed function and/or a movement of a cursor of the information processing device according to the determined touch positions and the determined touch motion, generating a command corresponding to the to-be-executed function and/or the movement of a cursor of the information processing device, and transmitting the generated command to the information processing device.

18. The non-transitory storage medium as described in claim 15, wherein the method further comprises, when the input mode is switched to the sketchpad input mode:
controlling the touch screen to display an operation interface having a user interface and an instrument interface listing a plurality of drawing instruments;
detecting the user operation in the user interface to determine the one or more touch positions and the touch motion in the operation interface; and
determining each selected drawing instrument in the instruments interface or determining each touch track in the user interface according to the determined touch positions and the touch motion, determining the property of each touch track according to the selected drawing instruments, combining each touch track with the corresponding determined property to generate an image, generating a command corresponding to the generated image, and transmitting the generated command to the information processing device.

19. The non-transitory storage medium as described in claim 18, wherein the method further comprises:
controlling the touch screen to display each touch track with the corresponding determined property in the user interface.

20. The non-transitory storage medium as described in claim 15, wherein the method further comprises, when the input mode is switched to the handwriting pen input mode:
controlling the touch screen to display a handwriting input interface;
detecting the user operation in the handwriting input interface to determine the one or more touch positions and the touch motion in the handwriting input interface;
determining each touch track in the user interface according to the determined touch positions and the touch motion, recognize a shape of the tracks, and determining the characters similarity to the recognized shape;
controlling the touch screen to display the determined characters; and
determining which character is selected according to the touched positions and the touched motion, generating a command according to the selected character, and transmitting the generated command to the information processing device.
